(19) United States
(12) Patent Application Publication
(10) Pub. No.: US 2010/0062302 A1
(43) Pub. Date: Mar. 11, 2010

(54) METAL SUPPORT AND SOLID OXIDE FUEL CELL INCLUDING THE SAME

(76) Inventors: Joongmyeon Bae, Daejeon (KR); Seung-Wook Baek, Daejeon (KR); Changbo Lee, Daejeon (KR); Gyujong Bae, Daejeon (KR); Yu-Mi Kim, Daejeon (KR); Jaehwa Jeong, Daejeon (KR)

Correspondence Address: CHRISTIE, PARKER & HALE, LLP, PO BOX 7068, PASADENA, CA, 91109-7068, US

(21) Appl. No.: 12/412,181

(22) Filed: Mar. 26, 2009

(30) Foreign Application Priority Data
Sep. 8, 2008 (KR) 10-2008-0088071

(51) Int. Cl. H01M 8/10

(52) U.S. Cl. 429/30

(57) ABSTRACT

Disclosed are a metal support for a solid oxide fuel cell and the solid oxide fuel cell including the metal support. The metal support is coupled to a separator of the solid oxide fuel cell by welding and supports one surface of a unit cell comprising a fuel electrode, an air electrode, and an electrolyte layer interposed between the fuel and air electrodes, wherein the metal support is in the form of a plate and has a welding portion welded to the separator on the outer circumference thereof and a hollow portion surrounded by the welding portion to allow a fuel gas or air to flow therethrough. The use of the metal support increases the mechanical strength of the solid oxide fuel cell, resulting in improved durability and extended service life of the solid oxide fuel cell. In addition, the metal support ensures a smooth flow of the fuel gas or air, resulting in an increase in the sealing efficiency and energy production efficiency of the solid oxide fuel cell.

### CROSS-REFERENCE OF RELATED APPLICATION

This application claims priority to and the benefit of Korean Patent Application No. 10-2008-0088071, filed on Sep. 8, 2008, in the Korean Intellectual Property Office, the entire content of which is incorporated herein by reference.

### BACKGROUND OF THE INVENTION

1. Field of the Invention

The present invention relates to a metal support and a solid oxide fuel cell including the metal support. More specifically, the present invention relates to a metal support coupled to a separator by welding and a solid oxide fuel cell using the metal support to achieve improved durability and high sealing efficiency and to ensure a smooth flow of a fuel gas or air, resulting in an increase in energy production efficiency.

2. Description of the Related Art

Fuel cells are devices that directly convert chemical energy produced by oxidation of fuel into electrical energy. Fuel cells are new environmentally friendly future energy technologies that generate electrical energy from abundant substances such as hydrogen and oxygen on the earth.

A typical fuel cell includes an air electrode as a cathode to which oxygen is supplied and a fuel electrode as an anode to which hydrogen is supplied. In the fuel cell, the oxygen and the hydrogen undergo electrochemical reactions as reverse reactions of water electrolysis to generate electricity, heat and water. As a result, the fuel cell produces electrical energy with high efficiency without causing environmental pollution.

Such fuel cells are free from the limitations of the Carnot cycle, which acts as a factor limiting the efficiency of conventional heat engines, resulting in a 40% or higher increase in efficiency. Fuel cells discharge water only, posing no risk of environmental pollution. Further, fuel cells possess many advantages of size reduction and no noise production because they include no mechanically moving parts, unlike conventional heat engines. Based on these advantages, much research on fuel cell technologies is actively underway.

Fuel cells are classified into phosphoric acid fuel cells (PAFCs), molten carbonate fuel cells (MCFCs), solid oxide fuel cells (SOFCs), polymer electrolyte membrane fuel cells (PEMFCs), direct methanol fuel cells (DMFCs) and alkaline fuel cells (AFCs) by the kind of electrolyte that they employ. The six types of fuel cells are available or are currently being developed in the art. The characteristics of the respective fuel cells are summarized in the following table.

| | Type | | | | | |
|---|---|---|---|---|---|---|
| | PAFC | MCFC | SOFC | PEMFC | DMFC | AFC |
| Electrolyte | Phosphoric acid | Lithium carbonate/ | Zirconia/ceria- | Hydrogen ion | Hydrogen ion | Potassium |
| | | potassium carbonate | based | exchange | exchange | hydroxide |
| | | | | membrane | membrane | |
| Ion conductor | Hydrogen ion | Carbonate ion | Oxygen ion | Hydrogen ion | Hydrogen ion | Hydrogen ion |
| Operation temp. | 200 | 650 | 500-1,000 | <100 | <100 | <100 |
| (° C.) | | | | | | |
| Fuel | Hydrogen | Hydrogen/carbon | Hydrogen, | Hydrogen | Methanol | Hydrogen |
| | | monoxide | hydrocarbon, | | | |
| | | | carbon monoxide | | | |
| Fuel material | City gas, LPG | City gas, LPG, coal | City gas, LPG, | Methanol, methane, | Methanol | Hydrogen |
| | | | hydrogen | gasoline, hydrogen | | |
| Efficiency (%) | 40 | 45 | 45 | 45 | 30 | 40 |
| Output range (W) | 100-5,000 | 1,000-1,000,000 | 100-100,000 | 1-10,000 | 1-100 | 1-100 |
| Application | Distributed | Large scale power | Small/middle/large | Power source for | Portable power | Power source |
| | power | generation | scale power | transportation | source | for spaceship |
| | generation | | generation | | | |
| Development stage | Demonstrated- | Tested-demonstrated | Tested- | Tested- | Tested- | Applied to |
| | actually used | | demonstrated | demonstrated | demonstrated | spaceship |

As can be known from the table, the fuel cells can be suitably selected according to the intended purpose taking into consideration their output ranges and applications. Of these, the solid oxide fuel cells (SOFCs) are advantageous in that it is relatively easy to control the position of electrolytes, there is no risk that electrolytes may be used up because the electrolytes are fixedly positioned, and the life of constituent materials is long due to the weak corrosiveness of electrolytes. Based on these advantages, the solid oxide fuel cells have drawn a great deal of attention for use in distributed power generators and in commercial and household applications.

According to the operational principle of a general solid oxide fuel cell, when oxygen is supplied to an air electrode and hydrogen is supplied to a fuel electrode, the following reactions occur in the respective electrodes.

Reaction in the fuel electrode (Anode): 2H₂+2O²⁻→2H₂O+4e⁻

Reaction in the air electrode (Cathode): O₂+4e⁻→2O²⁻

The solid oxide fuel cell uses YSZ (yttria-stabilized zirconia) as an electrolyte, Ni—YSZ cermet as a fuel electrode, a perovskite material as an air electrode, and oxygen ions as mobile ions.

FIG. 1 is a schematic view of a prior art solid oxide fuel cell 1. The solid oxide fuel cell 1 includes: a unit cell 10 including a fuel electrode 12, an air electrode 13, and an electrolyte layer 11 interposed between the fuel and air electrodes; current collectors 20 provided on both surfaces of the unit cell 10; and lower and upper separators 30a and 30b accommodating the unit cell 10 and the current collector 20 therein.

The separators 30a and 30b support the unit cell 10 and the current collectors 20. The separators 30a and 30b have supply passages 31a and 31b through which a fuel gas and air (oxygen) are supplied, respectively.

The fuel gas and air must flow in the solid oxide fuel cell 1 only through the defined passages. Mixing or leakage of the fuel gas and air considerably deteriorates the performance of the fuel cell 1, and there is thus a need for a highly advanced sealing technique to increase the performance of the fuel cell 1.

In the solid oxide fuel cell 1, glass-based sealing materials 40 are generally used to join the separators 30a and 30b and join the unit cell 10 to the separators 30b (In FIG. 1, the air electrode 13 is joined to the upper separator 30b by one of the sealing materials 40).

However, the glass-based sealing materials 40 do not have sufficiently high strength required in the solid oxide fuel cell 1 because they tend to be broken by an external impact. Further, the glass-based sealing materials 40 are readily deformed due to a repeated temperature change, making it difficult to expect sufficient sealing ability. These problems are main causes leading to deterioration in the performance of the solid oxide fuel cell 1.

The current collectors 20 are arranged between the unit cell 10 and the separators 30a and 30b to improve the electrical performance of the fuel cell 1. The current collectors 20 are in the form of a mesh made of a metal alloy or noble metal such that the fuel gas and air are uniformly supplied to the unit cell 10. However, the mesh type structure of the current collectors 20 renders the sealing of the fuel cell 1 more difficult.

To attain a sufficient voltage from the unit cell 10 as an only module, there is a need to increase the area of the unit cell 10 or laminate another unit cell on the unit cell 10 to form a stack. However, the requirements of mechanical strength and sealing performance are more difficult to meet.

### SUMMARY OF THE INVENTION

The present invention has been made in view of the above problems, and it is an object of the present invention to provide a metal support welded to a separator and a solid oxide fuel cell using the metal support to achieve improved durability and sufficiently high sealing efficiency to prevent mixing or leakage of a fuel gas and air.

According to one aspect of the present invention, there is provided a metal support for a solid oxide fuel cell which is coupled to a separator of the solid oxide fuel cell by welding and supports one surface of a unit cell comprising a fuel electrode, an air electrode, and an electrolyte layer interposed between the fuel and air electrodes, wherein the metal support is in the form of a plate and has a welding portion welded to a separator on the outer circumference thereof and a hollow portion surrounded by the welding portion to allow a fuel gas or air to flow therethrough.

The hollow portion of the metal support may be in communication with a supply passage of the separator through which the fuel gas or air is supplied and may have a continuous pattern.

The hollow portion of the metal support may be provided in plurality and the hollow portions may have a circular or polygonal shape in cross section.

According to another aspect of the present invention, there is provided a solid oxide fuel cell which includes: a unit cell including a fuel electrode, an air electrode, and an electrolyte layer interposed between the fuel and air electrodes; a pair of first and second separators coupled to each other to accommodate the unit cell therein; an insulating member provided between the pair of separators to insulate the separators from each other; a current collecting member provided between one surface of the unit cell and the second separator; and a metal support coupled to the first separator by welding to support the other surface of the unit cell, wherein the metal support is in the form of a plate and has a welding portion welded to the first separator on the outer circumference thereof and a hollow portion surrounded by the welding portion to allow a fuel gas or air to flow therethrough.

The first separator may have an inwardly indented seating portion at one side thereof to which the metal support is welded so as to allow the metal support to be seated on the seating portion.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a prior art solid oxide fuel cell;

FIG. 2 is an exploded perspective view of a solid oxide fuel cell according to one embodiment of the present invention;

FIGS. 3 and 4 are a cross-sectional view and an exploded cross-sectional view of the solid oxide fuel cell of FIG. 2, respectively;

FIG. 5 illustrates some shapes of a metal support for a solid oxide fuel cell according to one embodiment of the present invention;

FIG. 6 illustrates some shapes of a metal support for a solid oxide fuel cell according to another embodiment of the present invention; and

FIG. 7 is an exploded cross-sectional view of a solid oxide fuel cell according to another embodiment of the present invention.

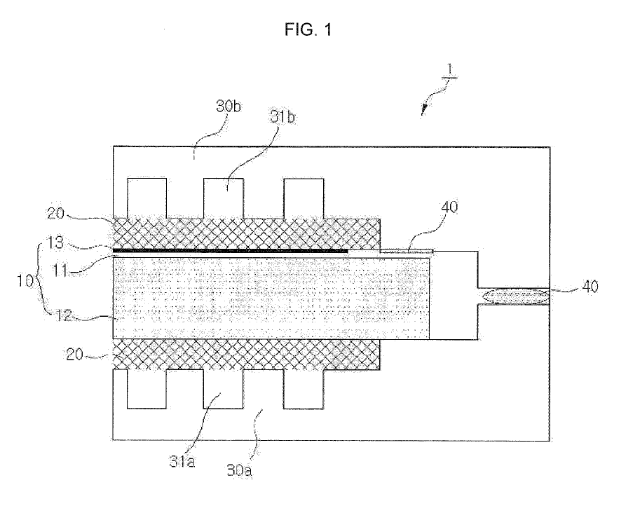

### DETAILED DESCRIPTION OF THE INVENTION

Exemplary embodiments of the present invention will now be described in detail with reference to the accompanying drawings.

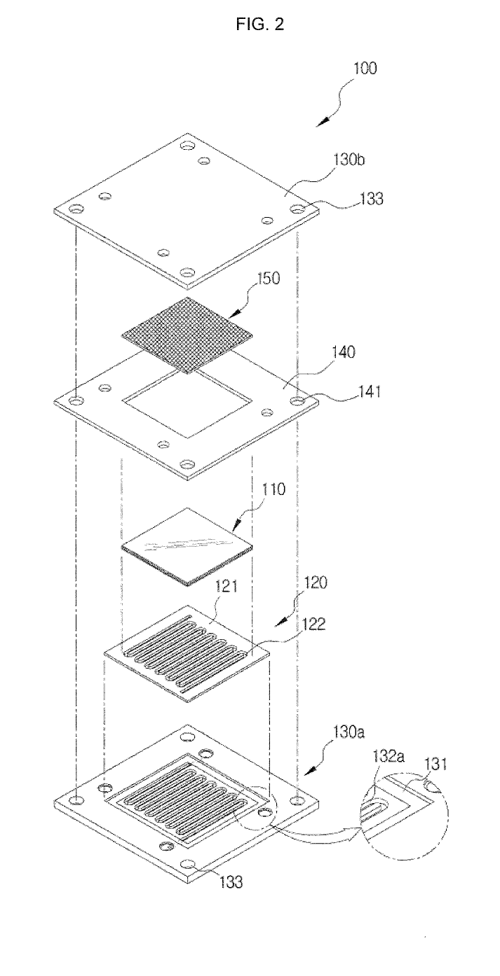

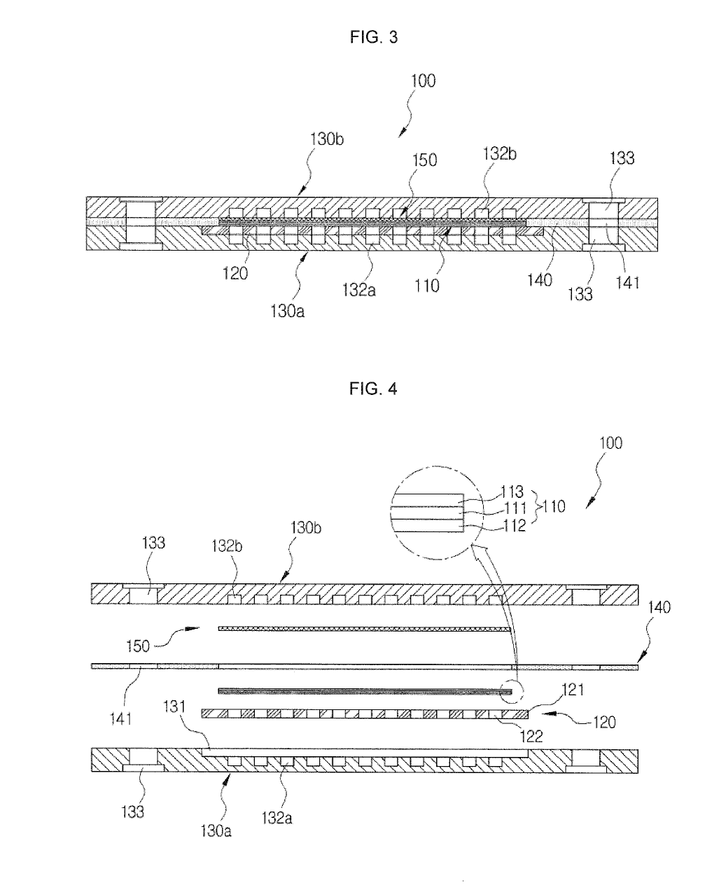

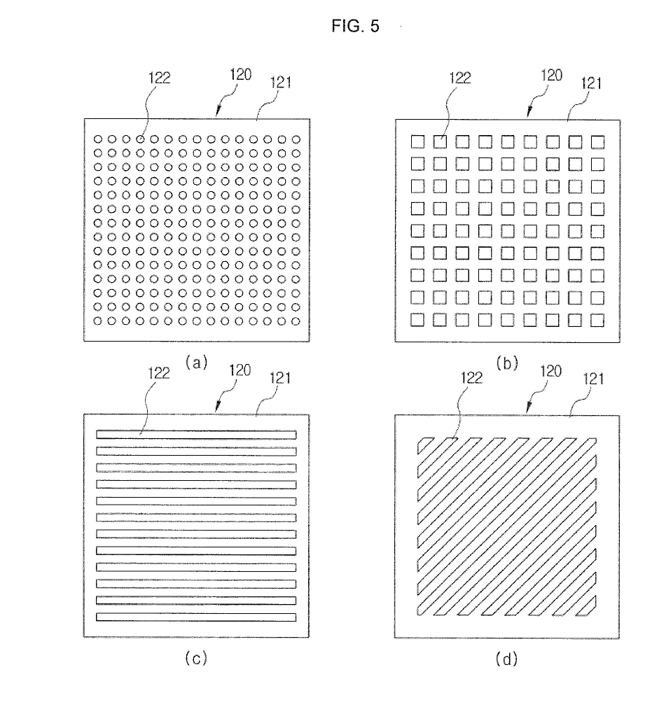

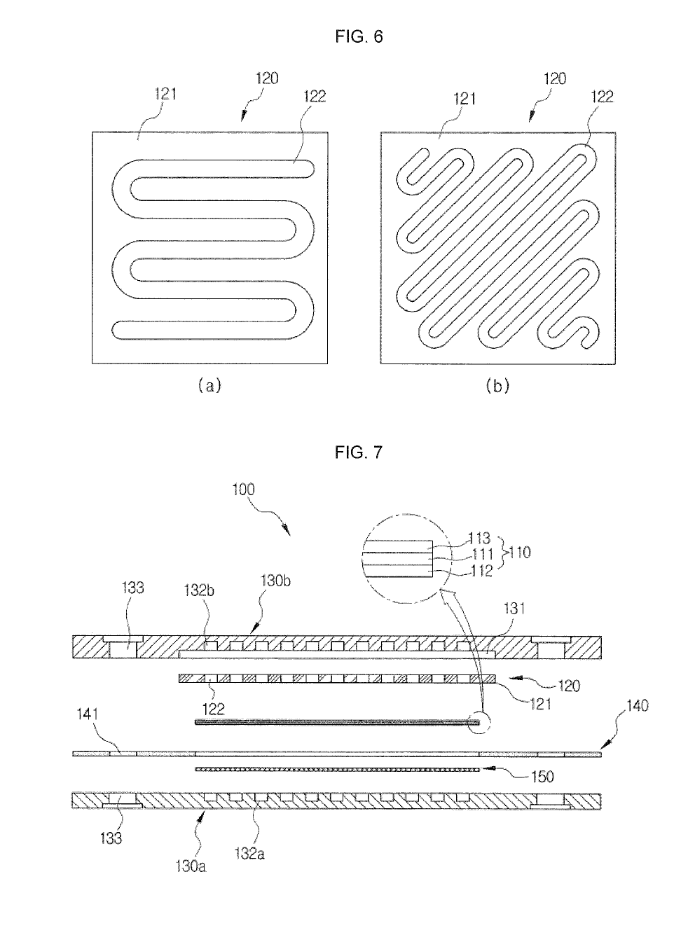

FIG. 2 is an exploded perspective view of a solid oxide fuel cell 100 according to one embodiment of the present invention, FIGS. 3 and 4 are a cross-sectional view and an exploded cross-sectional view of the solid oxide fuel cell 100 of FIG. 2, respectively, FIG. 5 illustrates some shapes of a metal support 120 for a solid oxide fuel cell according to one embodiment of the present invention, FIG. 6 illustrates some shapes of a metal support 120 for a solid oxide fuel cell according to another embodiment of the present invention, and FIG. 7 is an exploded cross-sectional view of a solid oxide fuel cell 100 according to another embodiment of the present invention.

The solid oxide fuel cell 100 of the present invention includes a metal support 120 as a constituent part. Hereinafter, the constitution of the solid oxide fuel cell 100 including the metal support 120 will be explained with reference to FIG. 2.

The solid oxide fuel cell 100 of the present invention includes a unit cell 110, a pair of first and second separators 130a and 130b, an insulating member 140 and a current collecting member 150 in addition to the metal support 120. The metal support 120 is in the form of a plate having a welding portion 121 welded to one of the separators 130a and a hollow portion 122 through which a fuel gas or air flows into the unit cell 110.

The unit cell 110 includes a fuel electrode 112, an air electrode 113, and an electrolyte layer 111 interposed between the two electrodes 112 and 113. One surface of the unit cell 110 is supported by the current collecting member 150 and the other surface thereof is supported by the metal support 120.

The metal support 120 is coupled to only one of the separators 130a and 130b by welding. The term ‘welding’ as used herein can be broadly interpreted to include brazing as well as all welding processes such as laser welding and argon welding.

FIGS. 2 through 4 illustrate an embodiment of the solid oxide fuel cell 100 in which the metal support 120 is disposed in contact with the fuel electrode 112 of the unit cell 110 and is joined to the first separator 130a, and the current collecting member 150 is provided between the air electrode 113 of the unit cell 110 and the second separator 130b.

The first and second separators 130a and 130b disposed at the outermost sides of the solid oxide fuel cell 100 are coupled to each other to protect the unit cell 110. The unit cell 110, the insulating member 140, the current collecting member 150 and the metal support 120 are accommodated in the first and second separators 130a and 130b.

Each of the separators 130a and 130b has fixing portions 133. The separators 130a and 130b are coupled to each other by the fixing portions 133. The first separator 130a has a supply passage 132a through which a fuel gas is supplied to the fuel electrode 112 and the second separator 130b has a supply passage 132b through which air is supplied to the air electrode 113.

Each of the supply passages 132a and 132b has supply holes through which the fuel gas or air is supplied from the outside and flow passages through which the fuel gas or air is guided to the entire region of the unit cell 110.

The fuel gas flows through the supply passage 132a adjacent to the fuel electrode 112 of the unit cell 110 and the air flows through the supply passage 132b adjacent to the air electrode 113 of the unit cell 110. Each of the supply passages 132a and 132b may have various shapes such that the fuel gas or air can flow uniformly over the entire region of the unit cell 110.

The supply passages 132a and 132b may have various forms. As illustrated in FIG. 2, the supply passages 132a and 132b are indented inwardly in the separators 130a and 130b to form flow passages in a continuous pattern, respectively. A plurality of protrusions may be formed in the separators 130a and 130b to guide a flow of the fuel gas or air and create a turbulent flow of the fuel gas or air.

The insulating member 140 is interposed between and in contact with the pair of separators 130a and 130b to insulate the separators from each other. As illustrated in FIG. 2, the insulating member 140 is in the form of a plate having the same size as the separators 130a and 130b. The insulating member 140 has a hollow portion in which the unit cell 110 and the current collecting member 150 are positioned. The insulating member 140 has the same height as the overall height of the unit cell 110 and the current collecting member 150. The insulating member 140 may have shapes other than the plate shape illustrated in FIGS. 2 through 4. The insulating member 140 may be a sealing material made of glass.

The plate-like insulating member 140 has fixing portions 141 through which the fixing portions 133 of the first separator 130a are coupled to the fixing portions 133 of the second separator 130b.

As illustrated in FIGS. 2 through 4, a seating portion 131 is indented inwardly in the first separator 130a welded to the metal support 120 to allow the metal support 120 to be seated thereon, leaving no portion of the metal support 120 protruding from the upper surface of the first separator 130a even when the metal support 120 is welded to the first separator 130a. In the case where the seating portion 131 is not formed, it is preferred to vary the dimensional factors (e.g., shape and height) of the insulating member 140 so that the insulating member 140, the unit cell 110, the metal support 120 and the other parts are brought into close contact with one another.

The current collecting member 150 serves to increase the collection efficiency of energy produced from the unit cell 110 and may have various forms (e.g., a mesh type) such that the air passes through the current collecting member 150 and smoothly flows into the unit cell 110.

Like the current collecting member 150, the metal support 120 serves to increase the current collection efficiency of the fuel cell 100. The metal support 120 is disposed on a surface of the unit cell 110 opposite to the current collecting member 150 to support the unit cell 110 and is welded to the first separator 130a to prevent leakage of the fuel gas.

The metal support 120 may be made of an electrically conductive material that has mechanical strength and heat resistance sufficient to support the unit cell 110 and to withstand welding heat, external impact, etc. without being deformed. Examples of the electrically conductive material include metals and alloys.

The metal support 120 is in the form of a plate such that the unit cell 110 can be sufficiently supported. The welding portion 121 is welded to the first separator 130a and surrounds the hollow portion 122 through which the fuel gas flows into the unit cell 110.

Herein, the hollow portion 122 of the metal support 120 is in communication with the supply passage 132a of the separator 130a to allow the fuel gas supplied through the supply passage 132a to smoothly flow into the unit cell 110.

FIGS. 5 and 6 illustrate various shapes of metal supports 120 for solid oxide fuel cells according to embodiments of the present invention. As illustrated in FIG. 5, the metal support 120 has a plurality of hollow portions 122 arranged at regular intervals. The hollow portions 122 have a circular or polygonal shape in cross section. Specifically, the cross section of the hollow portions 122 may be circular (5a), square (5b), elongated rectangular in a widthwise direction (5c), or trapezoidal in an oblique direction (5d).

As illustrated in FIG. 6, the metal support 120 has a hollow portion 122 as a continuous flow passage. It is to be understood that the shape of the metal support 120 is not limited to the shapes illustrated in FIGS. 5 and 6 so long as the metal support 120 can easily guide a fuel gas supplied from the first separator 130a to the unit cell 110.

The welding portion 121 is a region where the first separator 130a is welded to the metal support 120. In the case where the seating portion 131 is formed in the first separator 130a welded to the metal support 120, as illustrated in FIGS. 2 through 4, the outer circumference of the welding portion 121 of the metal support 120 is joined to the inner circumference of the seating portion 131 of the separator 130a.

FIG. 7 illustrates another embodiment of the present invention in which the metal support 120 is disposed in contact with the air electrode 113 of the unit cell 110 and the current collecting member 150 is disposed in contact with the fuel electrode 112.

As is apparent from the foregoing, the metal support of the solid oxide fuel cell according to the present invention is in the form of a plate having a hollow portion and a welding portion. The use of the metal support increases the mechanical strength of the solid oxide fuel cell, resulting in improved durability and extended service life of the solid oxide fuel cell. In addition, the metal support is directly welded to the first separator to prevent leakage or mixing of a fuel gas and air prior to reactions in the unit cell, achieving improved sealing performance of the solid oxide fuel cell. Therefore, the solid oxide fuel cell of the present invention is advantageous in terms of stability and energy production efficiency.

Although the present invention has been described herein with reference to the foregoing embodiments, these embodiments do not serve to limit the scope of the present invention. It should be understood that the present invention can be embodied in various different forms and many variations and modifications are possible without departing from the spirit and scope of the invention as defined by the appended claims.

What is claimed is:

1. A metal support for a solid oxide fuel cell, which is coupled to a separator of the solid oxide fuel cell by welding and supports one surface of a unit cell comprising a fuel electrode, an air electrode, and an electrolyte layer interposed between the fuel and air electrodes,
wherein the metal support is in the form of a plate and has a welding portion welded to the separator on the outer circumference thereof and a hollow portion surrounded by the welding portion to allow a fuel gas or air to flow therethrough.

2. The metal support of claim 1, wherein the hollow portion of the metal support is in communication with a supply passage of the separator through which the fuel gas or air is supplied.

3. The metal support of claim 2, wherein the hollow portion has a continuous pattern.

4. The metal support of claim 2, wherein the hollow portion of the metal support is provided in plurality.

5. The metal support of claim 4, wherein the hollow portions have a circular or polygonal shape in cross section.

6. A solid oxide fuel cell, comprising:
a unit cell comprising a fuel electrode, an air electrode, and an electrolyte layer interposed between the fuel and air electrodes;
a pair of first and second separators coupled to each other to accommodate the unit cell therein;
an insulating member provided between the pair of separators to insulate the separators from each other;
a current collecting member provided between one surface of the unit cell and the second separator; and
a metal support coupled to the first separator by welding to support the other surface of the unit cell,
wherein the metal support is in the form of a plate having a welding portion welded to the first separator on the outer circumference thereof and a hollow portion surrounded by the welding portion to allow a fuel gas or air to flow therethrough.

7. The solid oxide fuel cell of claim 6, wherein the first separator has an inwardly indented seating portion at one side thereof to which the metal support is welded so as to allow the metal support to be seated on the seating portion.
